(19) United States
(12) Patent Application Publication
(10) Pub. No.: US 2006/0231782 A1
(43) Pub. Date: Oct. 19, 2006

(54) CCD camera element used as actuation detector for electric plumbing products

(75) Inventors: Jeffrey Iott, Monroe, MI (US); Alfred C. Nelson, Carmel, IN (US)

Correspondence Address: CARLSON, GASKEY & OLDS, P.C., 400 WEST MAPLE ROAD, SUITE 350, BIRMINGHAM, MI, 48009, US

(73) Assignee: Masco Corporation

(21) Appl. No.: 11/105,900

(22) Filed: Apr. 14, 2005

(51) Int. Cl. F16K 31/02

(52) U.S. Cl. 251/129.04

(57) ABSTRACT

An improved method and control for identifying the presence of a user in the vicinity of a plumbing product utilizes a CCD camera to capture images. The captured images are analyzed to determine whether there is an actual user in a field of vision. If an actual user is determined to be in the image, then flow of water such as directing water outwardly of a faucet, or flushing of a toilet, is actuated. Further, the invention can be utilized in a tub and/or shower, and certain safety features can be provided by the control.

### BACKGROUND OF THE INVENTION

This invention relates to the use of a charged coupled device (CCD) camera, or other image capture device, utilized to detect the presence of a user in the vicinity of a plumbing product.

In the prior art, plumbing products, and in particular sinks or toilets, are provided with electronic controls to control actuation of the flow of water. The plumbing products typically incorporate an infrared unit, which sends out a light signal. When an object is in the proximity of the plumbing product, such as hands underneath a faucet spout, the signal is reflected and detected by the infrared unit. Water is then actuated.

There are some deficiencies in the current state of the art. In particular, the known controls are typically actuated based simply on a reflection of the signal. Thus, an object that may be stationary within the field could cause actuation of the water. Further, a change of intensity in the light such as may be caused by a change in the surrounding surface area can also cause actuation. As one example, a relatively shiny sink surface can pose a variety of problems for reflected signal control.

It would be desirable to have a more sensitive and intelligent method of determining the need for actuating a plumbing structure.

### SUMMARY OF THE INVENTION

In a disclosed embodiment of this invention, a control for a plumbing product is provided with a CCD camera. The CCD camera periodically captures an image of an area of interest, and conveys that image to a control memory. The image is analyzed, and a decision is made as to whether to actuate the plumbing product based upon the detected image. The use of the CCD camera provides a much more accurate and sensitive control over the plumbing product. As an example, the shape of the detected object, the color of the detected object, movement of the object can all be analyzed using the CCD images. Thus, the invention is much more sensitive than the existing art.

These and other features of the present invention can be best understood from the following specification and drawings, the following of which is a brief description.

### BRIEF DESCRIPTION OF THE DRAWINGS

FIG. 1 schematically shows a faucet incorporating the present invention.

FIG. 2 shows an image that may be captured by the FIG. 1 schematic.

FIG. 3 shows another image, which could be captured by the inventive schematic.

FIG. 4 shows another embodiment incorporated into a toilet.

FIG. 5 shows another embodiment utilizing a tub and/or shower.

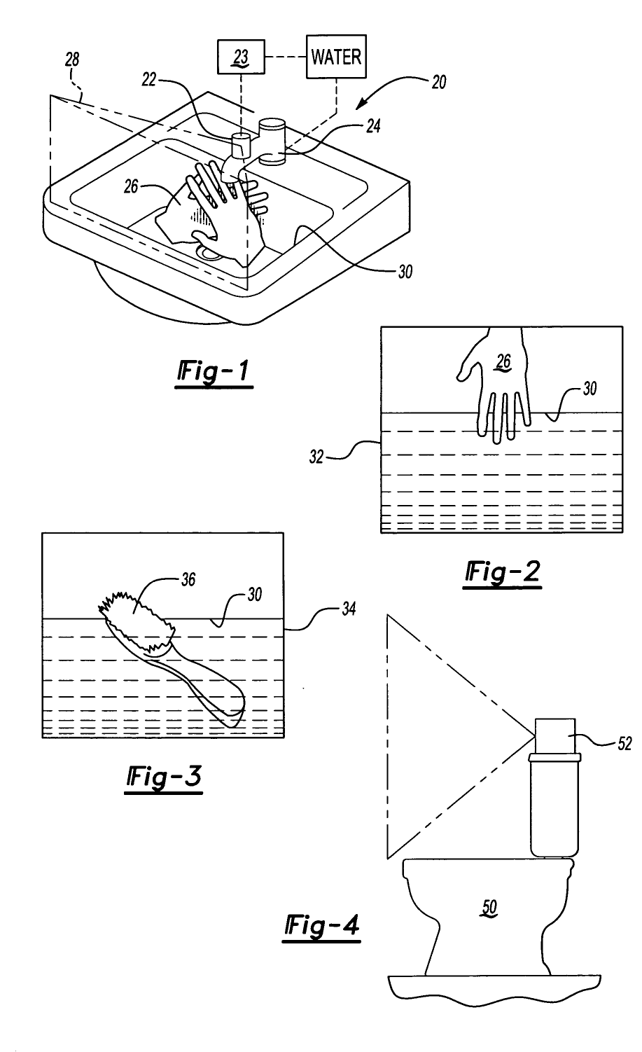

### DETAILED DESCRIPTION OF THE PREFERRED EMBODIMENT

A system 20 for making a control decision for actuation of a water faucet 24 includes a CCD camera 22. The CCD camera 22 periodically captures an image field 28 adjacent to the plumbing product. The CCD camera 22 supplies its captured images to a control 23. Control 23 is operable to actuate the flow of water from the faucet 24, as is known. However, what is novel here is the use of the CCD camera, and the use of captured images by the control 23.

As known, when a user 26 is detected in the vicinity of the faucet 24, then a decision should be made to actuate the water flow. As shown, a sink 30 surrounding the faucet 24 may have some portions in the captured field 28.

In the prior art, there have sometimes been false detections, and the actuation of water where it was not desired. By utilizing the CCD camera, the present invention provides a more sophisticated analytic ability, and thus the reduction of the number of false actuations.

As shown in FIG. 2, the captured image 32 would be pixilated and received at the control 23. The CCD camera 22 periodically captures such images, and thus successive images will be sent to control 23. The detected image can be compared to expected images for a user's hands, and analyzed. If the image is as shown in FIG. 2, and somewhat related to the hands of a user, either based on basic shape, distinction of color from the underlying sink, or any other analytic method, then the decision may be made to actuate the water flow. Control 23 can be programmed to store expected shapes or colors.

On the other hand, FIG. 3 shows an image 34, including an object 36, which should not be identified as indicating the flow of water. As an example, the object 36 does not extend across the boundaries of the captured image 34, and thus would be indicative of either a flaw in the captured image, or perhaps an object sitting stationery within the sink.

An object placed within the sink, in the prior art, would reflect a signal and actuate the flow of water. As mentioned above, by correlating the captured shape of an image to expected images of users, the present invention may eliminate many of these false actuations. Moreover, a user's hands would be within a range of expected colors, and those colors can be compared to a detected image, and the water not actuated unless the detected image is of an expected skin color. Alternatively, the control can be as simple as looking for a dramatic change in the captured image, which would be indicative of a user moving into the vicinity. Further, the control can identify the distance to the “user” such as the distance from a toilet. Here again, a number of false actuations can be eliminated.

The problem of the shiny surface, mentioned above, is completely avoided as reflected signals are not used.

CCD cameras are utilized in the prior art for detection of various images. Thus, software to analyze captured images is available and would be known to a worker of ordinary skill in the art. It is the application of this technology to the specific problem of identifying a need for actuating a plumbing product that is inventive here.

FIG. 4 shows a toilet 50 having a CCD camera to detect a user 52 in the vicinity. Again, and for reasons mentioned above, the present invention is able to better identify the actual need of actuating the toilet to flush. The present invention eliminates a number of false actuations that may have occurred in the prior art.

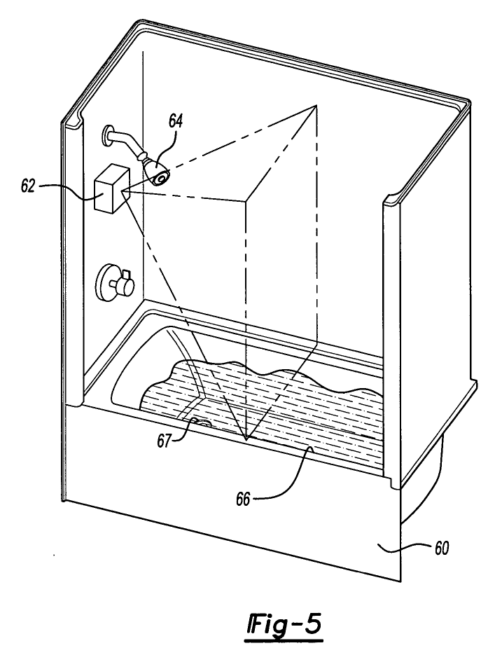

FIG. 5 shows an embodiment 60 incorporated into a tub/shower. The CCD camera 62 controls the flow of water from a spigot 64, which may be a shower or simply the fill spigot for the tub 60. The water flow can be actuated upon the detection of the presence of a user, and also various locations can be utilized to control things such as provided water temperature. The invention here would allow the shower to stop when the user leaves the vicinity, as one example.

Further, safety and/or other controls can be provided. As an example, the water level 66 can be monitored, and shut off when a desired water level is reached. Thus, a tub could be filled without the user having to monitor the filing of the tub. Moreover, should a user be seen as moving beneath the water level 66, some safety such as opening a drain 67 can be actuated. This would protect a younger user of the tub 60.

While a CCD camera is disclosed, other image capture devices, such as a CMOS device, could be utilized with this invention.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A plumbing product comprising:
a plumbing system for receiving a flow of water, and delivering a flow of water to the plumbing product;
a device for capturing images of the vicinity of the plumbing product; and
a control for analyzing said captured images from said device, and identifying a user in the vicinity of the plumbing product, and actuate the flow of water if the captured image is indicative of a user within the vicinity.

2. The plumbing product as set forth in claim 1, wherein said plumbing product is a sink faucet.

3. The plumbing product as set forth in claim 1, wherein said plumbing product is a toilet.

4. The plumbing product as set forth in claim 1, wherein said plumbing product is one of a tub and shower.

5. The plumbing product as set forth in claim 4, wherein said captured images are utilized to provide a safety control.

6. The plumbing product as set forth in claim 1, wherein said device is a CCD camera.

7. The plumbing product as set forth in claim 1, wherein said device is a CMOS camera.

8. The plumbing product as set forth in claim 1, wherein said captured images are analyzed based upon the approximate shape of a portion of the captured images and comparing the portion to expected shapes of a user.

9. The plumbing product as set forth in claim 1, wherein the color of a portion of said captured images is analyzed to determine the presence of a user.

10. The plumbing product as set forth in claim 1, wherein movement of a portion of said captured images is utilized to identify a user.

11. The plumbing product as set forth in claim 1, wherein a change in the captured image is utilized to identify a user.

12. A method of actuating a flow of water into a plumbing product comprising the steps of:
(1) providing a device for capturing images in the vicinity of a plumbing product;
(2) capturing images, and sending said captured images to a control to be analyzed;
(3) actuating a flow of water from said plumbing product if said control determines that a user is in the vicinity of the plumbing product based upon said captured images.

13. The method as set forth in claim 12, wherein the flow of water is water flowing outwardly of a sink faucet into a sink.

14. The method as set forth in claim 12, wherein the plumbing product is a toilet and the flow of water is utilized to flush the toilet.

15. The method as set forth in claim 12, wherein the plumbing product is one of a tub and shower.

16. The method as set forth in claim 15, wherein the captured images are utilized to provide a safety feature.

17. The method as set forth in claim 12, wherein said device is a CCD camera.

18. The method as set forth in claim 12, wherein said device is a CMOS camera.

19. The method as set forth in claim 12, wherein the approximate shape of a portion of said captured images is utilized to identify a user.

20. The method as set forth in claim 12, wherein a color of a portion of said captured images is utilized to identify the presence of a user.

21. The method as set forth in claim 12, wherein movement of a portion of said captured images between successive captured images is utilized to identify the presence of a user.
